(19) United States
(12) Patent Application Publication
(10) Pub. No.: US 2015/0026130 A1
(43) Pub. Date: Jan. 22, 2015

(54) METHOD FOR EFFICIENT MANAGEMENT OF EMAIL ATTACHMENTS

(71) Applicant: LiveQoS Inc., Ottawa (CA)

(72) Inventors: Martin William Horne, Woodlawn (CA); Mohan Krishna Vemulapali, Nepean (CA); James Robert McMillan, Dunrobin (CA); Matthew Robert Williams, Kanata (CA)

(21) Appl. No.: 13/944,361

(22) Filed: Jul. 17, 2013

(51) Int. Cl. G06F 17/30

(52) U.S. Cl. CPC G06F 17/30174; G06F 17/30011
USPC 707/635; 707/637

(57) ABSTRACT

A system for managing email attachments receives and opens, on a mobile device, a document attached to an email; converts the opened document to a lower-resolution document; stores the lower-resolution document; and synchronizes the stored lower-resolution document with the mobile device. The system can also generate and store a corresponding thumbnail of the lower-resolution document. The original of the opened document may be stored in a remote storage device, optionally encrypting the low-resolution document before storing. The original of the opened document may also be broken into a plurality of pieces which are stored in different remote storage devices.

### FIELD OF THE INVENTION

The present disclosure relates to management of email attachments.

### BACKGROUND

There are existing applications that mine emails for attachments and save the attachments on a cloud server so they are available from any locations. These services allow for sharing of the files and cataloguing based on policies. Referring to FIG. 1, a user 100 registers at 10 with a mining service 105. The mining service in turn sets up the data mining function 102 with the user configurations and the different email services 101a . . . 101m to be searched by a data mining function 102 for attachments or links to files within the user's emails of one or more email accounts 101a . . . 101m. The data mining function 102 provides information to a search engine 103 which maintains metadata 103a for quick access. The email attachments 60 are classified by a classification engine 104 and stored to existing remote storage devices such as cloud-based file management services 106a . . . 106n. A cloud email attachment service administration 105 manages the users (e.g., add/remove users, modify preferences and policies). The administration 105 also handles search requests 30 from the users by querying 50 the search engine 103 and returns the relevant files 40.

Accessing these files using a mobile device can be a problem since the files are often too big to be stored on the device or there are no applications on the device capable of rendering the file. Furthermore, there is a need to efficiently manage email attachments so they are readily available on a mobile device regardless of whether connectivity is available or of good quality.

### BRIEF SUMMARY

In accordance with one embodiment, a method for managing email attachments comprises receiving and opening, on a mobile device, a document attached to an email; converting the opened document to a lower-resolution document; storing the lower-resolution document, and synchronizing the stored lower-resolution document with the mobile device. The method preferably also generates and stores a corresponding thumbnail of the lower-resolution document. In one implementation, the original of the opened document is also stored in a remote storage device. The original of the opened document may be broken into a plurality of pieces which are stored in different remote storage devices, preferably encrypting the low-resolution document before storing that document.

In one implementation, the mobile device includes a low-resolution document application, and the stored lower-resolution document is retrieved from storage and sent to the mobile device. A corresponding thumbnail of the lower-resolution document may be retrieved from storage and sent to the application.

In another embodiment, a method of adding redundancy to remote storage services, comprises breaking a file to be stored into two or more pieces; adding redundancy pieces; and storing the different pieces the different pieces are stored in different remote storage devices. Each of the pieces is preferably stored in a different remote storage device.

In a further embodiment, a method of accelerating access to one or more files by a device based on the location of the device comprises storing the one or more files at different geographical locations in remote storage devices, and retrieving the files that are located closest to the location of the device used to access the stored files.

In yet another embodiment, a method for optimizing usage of free cloud storage services, comprises storing files across different cloud storage services, and viewing the different cloud storage services as a single drive.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 is an example of existing cloud email attachment management services.

FIG. 2 is an embodiment of an efficient email attachment management services for mobile devices.

FIG. 3 is an example of an application using a network performance measurement module.

FIG. 4 is a flow chart exemplifying the model of the sharing of low-resolution documents.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

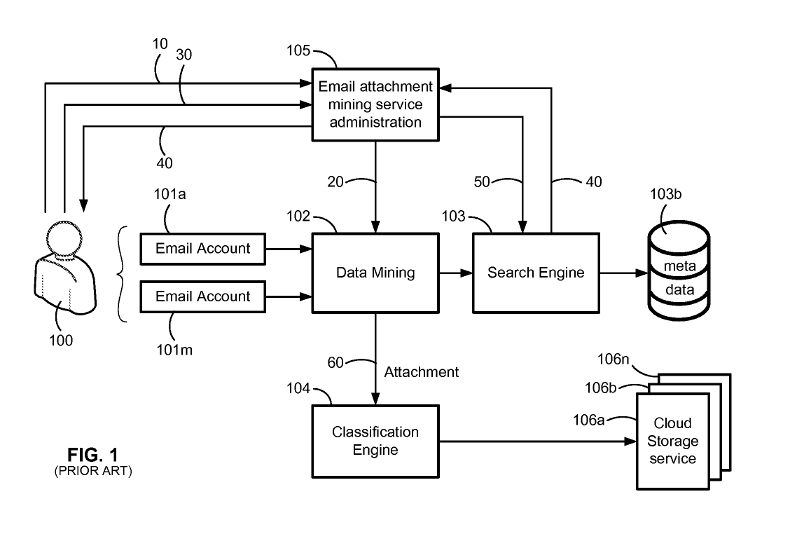

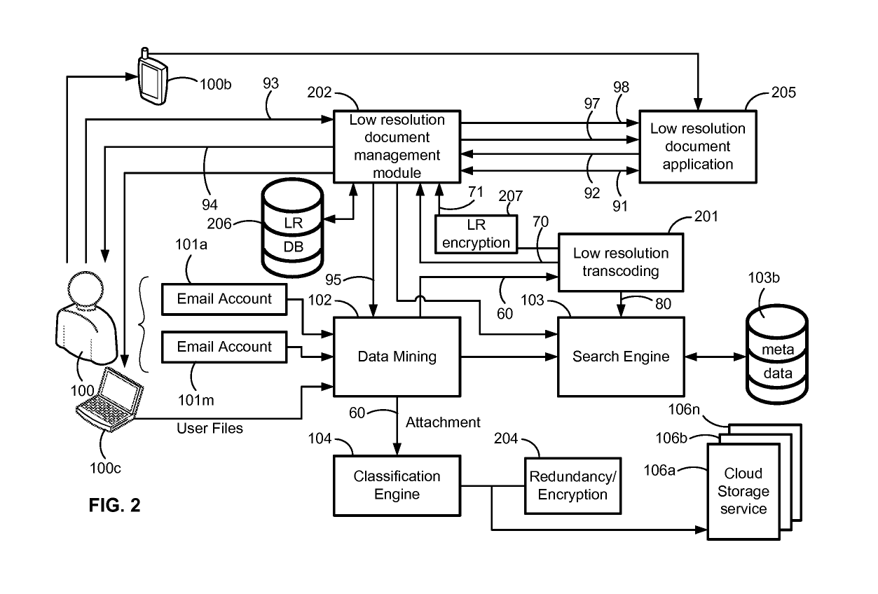

Referring to FIG. 2, as a complement to the email attachment mining described in FIG. 1, there is provided a system and method to access low-resolution renderings of email attachments to the mobile device 100b of a user 100. The user 100 installs a low-resolution document (LRD) application 205 on a mobile device 100b. The user 100 registers with a low-resolution document management module 202 at 92 and sets up configuration and policies for email accounts 101a . . . 101m. In one embodiment, email attachments 60 (also referred to herein as original files) that are extracted at 102 from emails, or from links within emails, are compressed and/or transcoded at 201 into LRDs 70. Optionally, the user can input files directly into the data mining system 102 using a computing device 100c. A key 80 to the LRD is provided to the search engine 103 to facilitate future searches.

The LRDs 70 are sent to a low-resolution document management module 202 which maintains a database 206 of the LRDs. Optionally, the LRD is encrypted at 207 prior to storing in an LRD database 206. Thumbnails 91 of the LRDs are generated in the management module 202 and stored in the LRD database 206. The thumbnail 91 and the LRD 70 are kept in synchronization with the mobile device 100b when the mobile device has access to a network. Optionally, the LRD is encrypted at 207 before being stored in the database 206, and is sent as an encrypted message to the LRD application 205 located on the mobile device 205. The LRD application 205 is used to display the thumbnails 91 and to view the LRD 70. When required, the application 205 handles the decryption of encrypted LRDs. The synchronization between the LRD database 206 and the mobile phone 100b can be done using a push or pull method or any known mobile file synchronization technique. Either the application 205 or the user 100 (via a computer) can request that the original files corresponding to LRDs be transmitted to the application 205, at 97. The LRD management module 202 is notified and keeps of the LRDs being downloaded and manages the file on the mobile devices 100b according to the set-up policies.

To create a low-resolution document from an original file, the file (e.g. PDF) can be transcoded to an image and then optionally compressed. Other office-type editing files (e.g., Microsoft® office files) are first converted to PDF files or any other image format. Optionally, images are extracted from the original file and transcoded/compressed to lower resolution and then inserted back into the file. The file as a whole can be transcoded/compressed into a low-resolution document. The original files are stored in cloud storage services 106, which can include any enterprise- hosted storage services or systems, based on policies from a rules engine 203.

Optionally, the original files are encrypted at 204 before being stored on the cloud storage service 106. More than one cloud storage service 106 can be used to store the original files. In one embodiment, the files are duplicated on two or more cloud storage services 106a . . . 106n to ensure redundancy. In another embodiment, copies of the original files are distributed at different geographical cloud storage services locations, and location-based information is used to extract the closest original file when required to speed up the download. A further embodiment, the original files are stored in a way to optimize the use of free space on different cloud storage services 106, and in that case all the different cloud storage services are seen as one drive.

A large original file may be divided into a plurality of (two or more) pieces and redundancy is added in order to be able to recover the original file should one piece be lost. Any known redundancy technique can be used for recovering the original file. Each piece of the original file is stored on a different remote storage device, e.g., cloud storage service, to improve redundancy in an efficient manner.

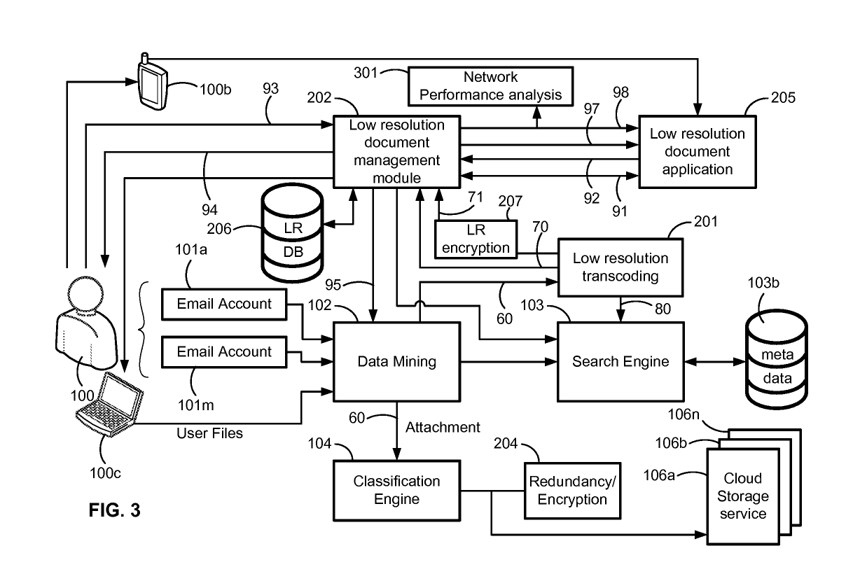

Referring to FIG. 3, as another embodiment, different quality low-resolution documents of the original files are stored in the low-resolution database 206. A network performance analysis module 301 monitors the quality of the network connection with the mobile device and depending on the assessed network performance where the mobile device is connected, a higher or lower resolution document is selected for download on the mobile device based on user-configured policies.

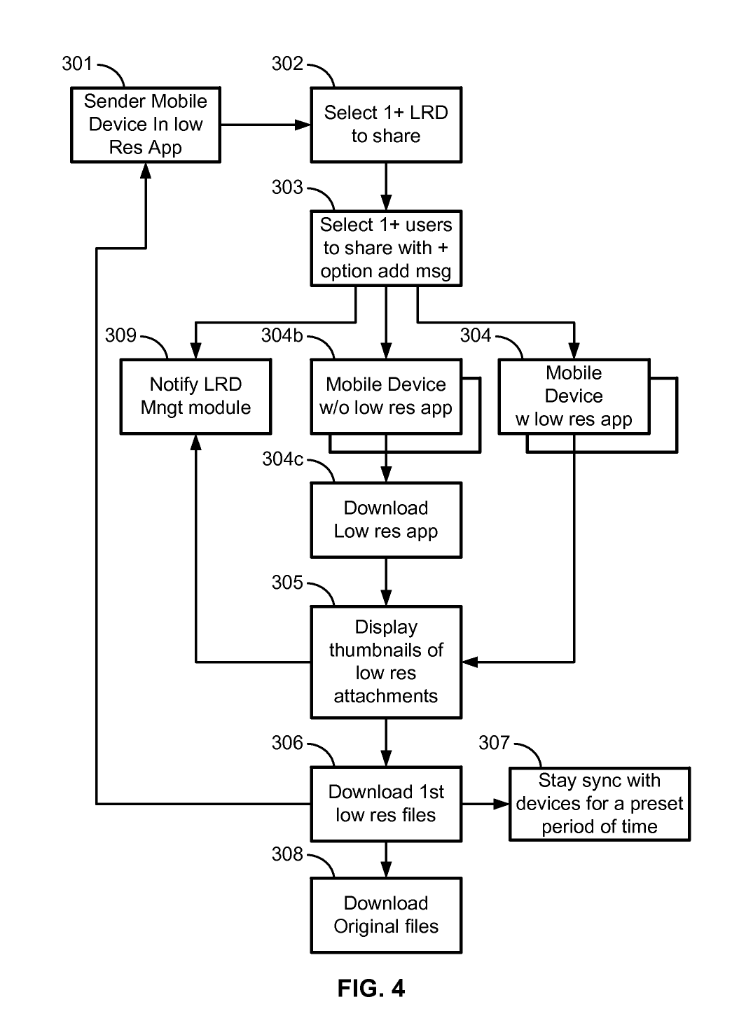

Referring to FIG. 4, in another embodiment, a user of the LRD application on the mobile device 100b can share documents by selecting one or more document(s) to share at 302 and one or more recipients' email addresses along with an optional message at 303. The email is sent to the recipient users. Optionally, the email is encrypted before being sent. If the recipient already has the LRD application on its mobile device 304, it can then view the thumbnails of the low-resolution document(s) at 305 and select to download one or more of the low-resolution documents 306. If the recipient mobile device does not have the LRD application 304b, then the application is first downloaded at 304c onto the device. When the downloads are complete, the recipient device can optionally maintain synchronization with the low-resolution document at 307 either permanently or only for a predetermined period of time as prescribed by the policies set up by the sender.

There can be also a configurable option to allow download of the original file related to the low-resolution document at 308. The email can optionally include one or more other policies parameters. For example a time-to-live wherein the low-resolution documents downloaded and associated emails are automatically deleted from the recipient mobile devices 304, 304b. The LRD management function 202 also has an optional capability of wiping off remotely any documents (original files or LRD) and related emails shared using the system. Depending on configurable policies, the recipient mobile device can forward the email with the LRD thumbnails to other users. The LRD management function 202 can optionally keep track of where the files are sent, in order to allow future deletion.

File names or any type of descriptor for the content of the document can replace thumbnails.

Referring to FIG. 3, a network performance analysis module 301 can be included with the system. The network performance analysis module 301 monitors the quality of the connections (e.g., throughput, file transfer performance) of the active users to put together a map of the best quality networks available (e.g., 3G, 4G, LTE, WIFI hotspots) in an area. This way all the users are crowd-sourcing the network performance information based on their location. Using this feature, a user can locate the most efficient WIFI hotspot to connect to for improved network throughput for better file transfer, web browsing, video streaming or virtual desktop performance

Although the algorithms described above have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that algorithms are illustrated and discussed herein as having various modules which perform particular functions and interact with one another. It should be understood that these modules are merely segregated based on their functions for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A method for managing email attachments comprising.
receiving and opening, on a mobile device, a document attached to an email,
converting the opened document to a lower-resolution document,
storing said lower-resolution document, and
synchronizing the stored lower-resolution document with the mobile device.

2. The method of claim 1 which includes creating a corresponding thumbnail of said lower-resolution document.

3. The method of claim 1 which includes storing the original of the opened document in a remote storage device.

4. The method of claim 3 which includes breaking said original of the opened document into a plurality of pieces and storing each piece in a different remote storage device.

5. The method of claim 5 in which said mobile device includes a low-resolution document application, and the stored lower-resolution document is retrieved from storage and sent to said mobile device.

6. The method of claim 5 which includes encrypting said low-resolution document before storing that document.

7. The method of claim 6 in which said low-resolution document is sent to a low-resolution document management module that maintains a database of low-resolution documents.

8. The method of claim 7 which includes decrypting low-resolution documents that have been encrypted, in said low-resolution document application.

9. The method of claim 6 which includes creating a corresponding thumbnail of said lower-resolution document, and said thumbnail is retrieved from storage and sent to said application.

10. A method of adding redundancy to remote storage services, comprising
breaking a file to be stored into two or more pieces,
adding redundancy pieces, and
storing the different pieces the different pieces are stored in different remote storage devices.

11. The method of claim 10 in which each of said pieces is stored in a different remote storage device.

12. The method of claim 10 in which said remote storage devices are cloud storage services.

13. A method of accelerating access to one or more files by a device based on the location of said device, comprising
storing said one or more files at different geographical locations in remote storage devices, and
retrieving the files that are located closest to the location of the device used to access the stored files.
